(19) United States
(12) Patent Application Publication
(10) Pub. No.: US 2026/0357903 A1
(43) Pub. Date: Nov. 12, 2026

(54) GATE VALVE WITH REDUCED GREASE USAGE

(71) Applicant: Downing Wellhead Equipment, LLC, Oklahoma City, OK (US)

(72) Inventors: Jason Jansing, Norman, OK (US); Nischit Reddy Kadari, Oklahoma City, OK (US)

(21) Appl. No.: 19/670,127

(22) Filed: May 7, 2026

Related U.S. Application Data
(60) Provisional application No. 63/801,344, filed on May 7, 2025.

(51) Int. Cl. F16K 3/36; E21B 34/00; F16K 3/02

(52) U.S. Cl. CPC F16K 3/36; E21B 34/00; F16K 3/0227

(57) ABSTRACT

A gate valve with reduced grease usage according to which a valve seat assembly includes a grease retainer plate, a volumetric insert, and a seat element.

### CROSS-REFERENCE TO RELATED APPLICATIONS

This application claims the benefit of the filing date of, and priority to, U.S. Patent Application No. 63/801,344 (the “’344 Application”), filed May 7, 2025 bearing Attorney Docket No. 57959.45PV01, the entire disclosure of which is hereby incorporated herein by reference.

### TECHNICAL FIELD

This present application relates generally to gate valves, and, more particularly, to gate valves that reduce grease usage in oil and gas operations (e.g., hydraulic fracturing operations).

### BACKGROUND

For many existing gate valve designs, when the gate is in the open position to permit fluid passage from the upstream side to the downstream side of the valve, there is insufficient sealing between the gate and the seats, allowing wellbore fluid into the body cavity and resulting in the body cavity pressure being the same as the valve flow bore pressure. On the other hand, when the gate is in the closed position, flow from the upstream direction pushes the gate towards the downstream seat, forming a seal (e.g., a metal-to-metal seal) between the downstream seat and the gate face, and between the downstream seat and the seat pocket in the valve body. However, even though the downstream side of the valve is sealed when the gate is in the closed position, there is still insufficient sealing on the upstream side of the valve, resulting in wellbore fluid still being allowed into the body cavity. Moreover, when the gate is being closed from the open position, there is direct interaction between the wellbore fluid and the grease in the body cavity. Specifically, wellbore fluid from the upstream valve flow bore is permitted passage through the gate bore and into the downstream side of the body cavity, forcing some of the grease out of the body cavity and into the gate bore—this grease is washed downstream out of the gate bore. Similarly, when the gate is opened from the closed position, any grease that has migrated from the body cavity into the gate bore is displaced into the valve flow bore and washed downstream out of the gate bore. In order to ensure that the body cavity is filled with grease at all times, any grease washed downstream must be replaced, for example, by pushing new grease into the body cavity via grease lines connected to injection ports in the valve body. In many instances, each valve requires several pounds of grease after every stage and before the next stage during hydraulic fracturing operations. Therefore, apparatus, system(s), and/or method(s) for addressing these issues, and/or one or more other issues commonly associated with existing gate valve designs, are needed.

### BRIEF DESCRIPTION OF THE DRAWINGS

FIG. 1A is a cross-sectional perspective view of a gate valve including a valve body, a seat assembly, a gate assembly, an operating end, and a balancing end, according to one or more embodiments of the present disclosure.

FIG. 1B is a cross-sectional elevational view of the gate valve of FIG. 1A, including the valve body, the seat assembly, the gate assembly, the operating end, and the balancing end, according to one or more embodiments of the present disclosure.

FIG. 2 is a cross-sectional elevational view of the valve body of FIGS. 1A and 1B, according to one or more embodiments of the present disclosure.

FIG. 3 is an exploded cross-sectional elevational view of the seat assembly of FIGS. 1A and 1B, according to one or more embodiments of the present disclosure.

FIG. 4A is a front elevational view of a volumetric insert of the seat assembly of FIG. 3, according to one or more embodiments of the present disclosure.

FIG. 4B is a side elevational view of the volumetric insert of FIG. 4A, according to one or more embodiments of the present disclosure.

FIG. 4C is a cross-sectional view of the volumetric insert of FIGS. 4A and 4B taken along the line 4C-4C of FIG. 4B, according to one or more embodiments of the present disclosure.

FIG. 5 is a cross-sectional perspective view of the gate assembly of FIGS. 1A and 1B, according to one or more embodiments of the present disclosure.

FIG. 6A is a cross-sectional elevational view of the gate valve of FIGS. 1A-5 in an open configuration, the gate valve including the valve body, the seat assembly, the gate assembly, the operating end, and the fluid end, according to one or more embodiments of the present disclosure.

FIG. 6B is an enlarged view of a portion of the cross-sectional elevational view of FIG. 6A in the open configuration, according to one or more embodiments of the present disclosure.

FIG. 7A is a cross-sectional elevational view of the gate valve of FIGS. 1A-5 in a partially-open configuration, according to one or more embodiments of the present disclosure.

FIG. 7B is an enlarged view of a portion of the cross-sectional elevational view of FIG. 7A in the partially-open configuration, according to one or more embodiments of the present disclosure.

FIG. 8A is a cross-sectional elevational view of the gate valve of FIGS. 1A-5 in a closed configuration, according to one or more embodiments of the present disclosure.

FIG. 8B is an enlarged view of a portion of the cross-sectional elevational view of FIG. 8A in the closed configuration, according to one or more embodiments of the present disclosure.

### DETAILED DESCRIPTION

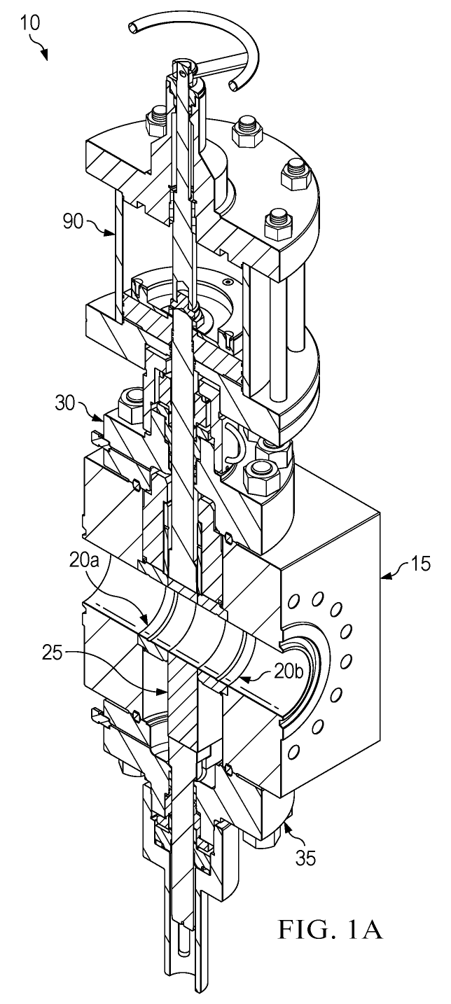

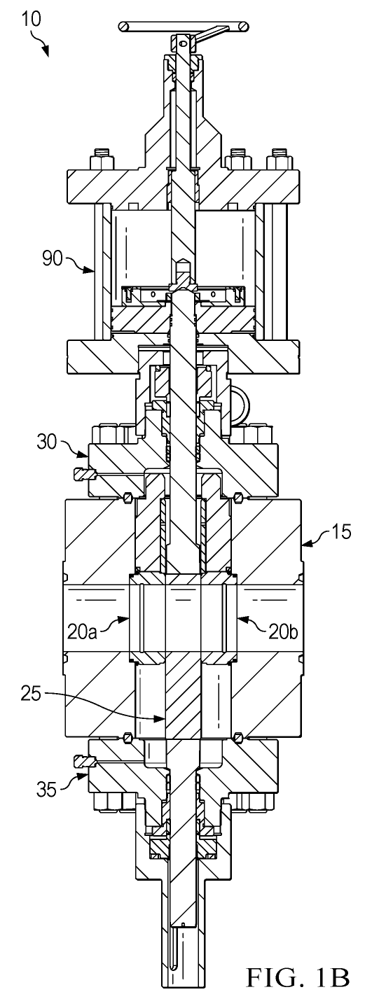

Referring to FIGS. 1A and 1B, a gate valve 10 is illustrated, according to one or more embodiments of the present disclosure. The gate valve 10 includes a valve body 15, a pair of valve seat assemblies 20a, 20b engaged with the valve body 15, a gate assembly 25 extending within the valve body 15 and accommodated by the valve seat assemblies 20a, 20b, an operating end assembly 30 connected to the valve body 15, and a balancing end assembly 35 connected to the valve body 15, opposite the operating end assembly 30. The gate assembly 25 is enclosed within the valve body 15, the operating end assembly 30, and the balancing end assembly 35. The operating end assembly 30 is adapted to actuate the gate assembly 25 between an open configuration, in which a fluid is permitted to flow through the valve body 15, and a closed configuration, in which the fluid is restricted from flowing through the valve body 15. The balancing end assembly 35 accommodates a portion of the gate assembly 25 and balances forces exerted on the gate assembly 25 during operation of the gate valve 10. The valve seat assemblies 20a, 20b are positioned on either side of the gate assembly 25, and maintain the alignment of the gate assembly 25 during the actuation thereof between the open and closed configurations.

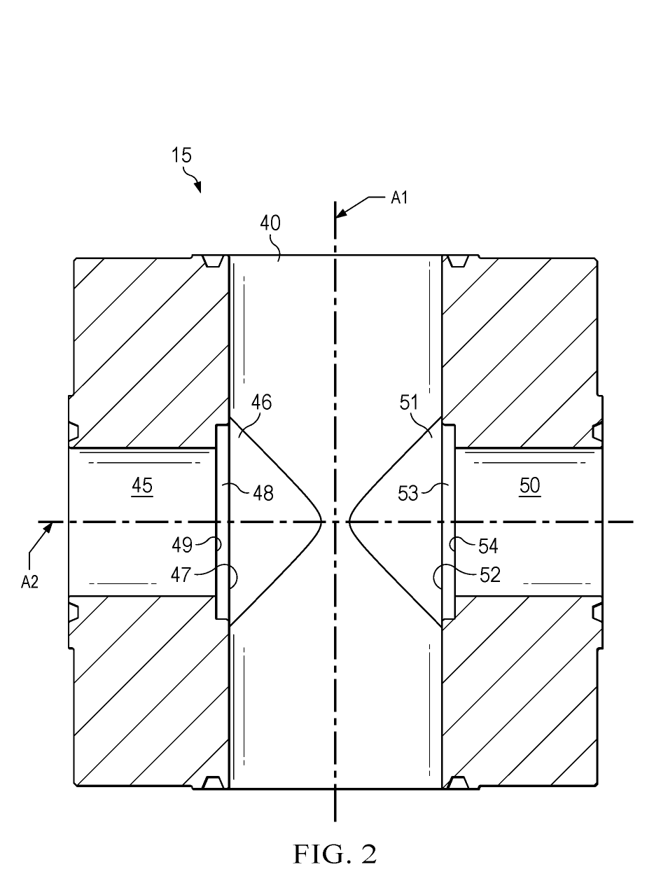

Referring to FIG. 2, with continuing reference to FIGS. 1A and 1B, a cross-sectional elevational view of the valve body 15 is illustrated, according to one or more embodiments of the present disclosure. The valve body 15 includes an internal region 40, such as, for example, a passage or bore, extending therethrough along a center axis A1. In one or more embodiments, the internal region 40 is generally cylindrical. A fluid bore 45 extends through the valve body 15 along a center axis A2 and intersects the internal region 40. In one or more embodiments, the fluid bore 45 is generally cylindrical. In one or more embodiments, the center axis A2 is substantially perpendicular to the center axis A1 of the internal region 40. An annular recess 46 is formed in the fluid bore 45, adjacent the internal region 40. More particularly, the annular recess 46 adjoins the internal region 40 and defines an internal annular shoulder 47 in the valve body 15. Another annular recess 48 is formed in the fluid bore 45, adjacent the annular recess 46. More particularly, the annular recess 48 adjoins the annular recess 46 and defines an internal annular shoulder 49 in the valve body 15.

Another fluid bore 50 extends through the valve body 15 along the center axis A2, opposite the fluid bore 45, and intersects the internal region 40. In one or more embodiments, the fluid bore 50 is generally cylindrical. Yet another annular recess 51 substantially similar to the annular recess 46 is formed in the fluid bore 50, adjacent the internal region 40. More particularly, the annular recess 51 adjoins the internal region 40 and defines yet another internal annular shoulder 52 in the valve body 15. Still yet another annular recess 53 substantially similar to the annular recess 48 is formed in the fluid bore 50, adjacent the annular recess 51. More particularly, the annular recess 53 adjoins the annular recess 51 and defines still yet another internal annular shoulder 54 in the valve body 15.

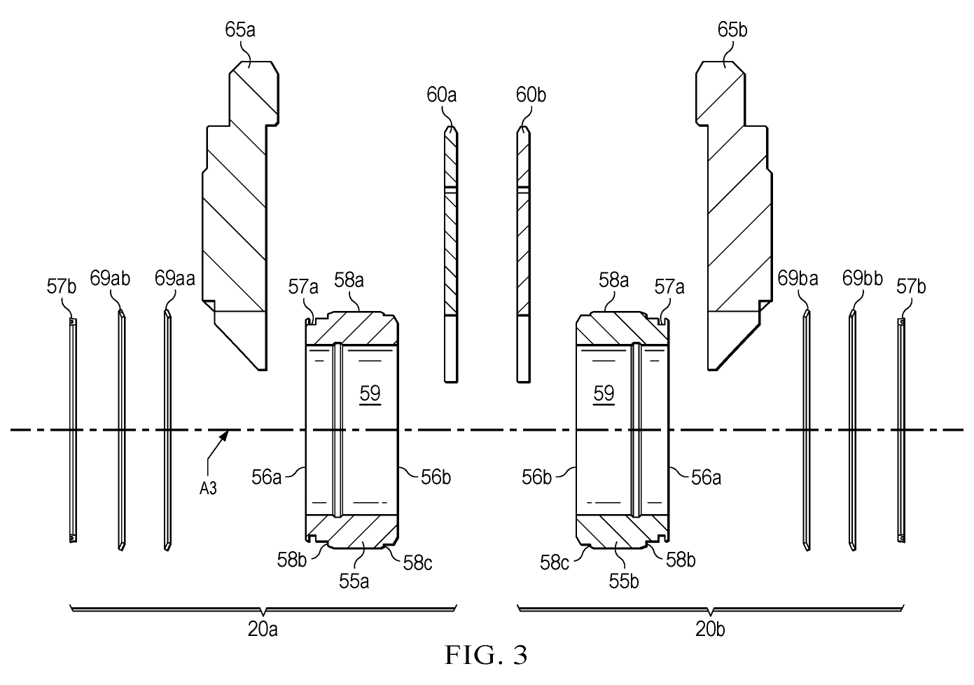

Referring to FIG. 3, with continuing reference to FIGS. 1A-2, in one or more embodiments, the valve seat assembly 20a includes a seat element 55a, a corresponding grease retainer plate 60a, and a corresponding volumetric insert 65a. In one or more embodiments, the grease retainer plate 60a and the volumetric insert 65a are together referred to herein as an embodiment of a “grease retention apparatus”. The seat element 55a is a tubular (also referred to herein as “annular”) (e.g., generally cylindrical) member defining a pair of opposing end faces 56a and 56b. Additionally, the seat element 55a includes an external annular groove 57a formed in an exterior of the seat element 55a proximate the end face 56a thereof. The external annular groove 57a accommodates an annular seal 57b. Finally, the exterior of the seat element 55aincludes an enlarged-diameter portion 58a between the external annular groove 57a and the end face 56b, which enlarged-diameter portion 58a defines a pair of opposing external annular shoulders 58b, 58c in the seat element 55a. Specifically, the external annular shoulder 58b faces toward the external annular groove 57a and the end face 56a, while the external annular shoulder 58c faces toward the end face 56b. A fluid bore 59 extends through the seat element 55a, along a center axis A3, which is substantially coaxial with the center axis A2 of the valve body 15. In one or more embodiments, the fluid bore 59 is generally cylindrical. The end face 56a of the seat element 55a abuts, or nearly abuts, the internal annular shoulder 49 in the valve body 15. The grease retainer plate 60a at least partially circumscribes an exterior of the seat element 55a and is supported, for example, in a substantially parallel relation to a grease retainer plate 60b. Specifically, in one or more embodiments, the grease retainer plate 60a at least partially circumscribes the exterior of the seat element 55a so as to abut, or nearly abut, the external annular shoulder 58c thereof. In one or more embodiments, when so positioned, at least a portion of the grease retainer plate 60a is substantially co-planar with the end face 56b of the seat element 55a.

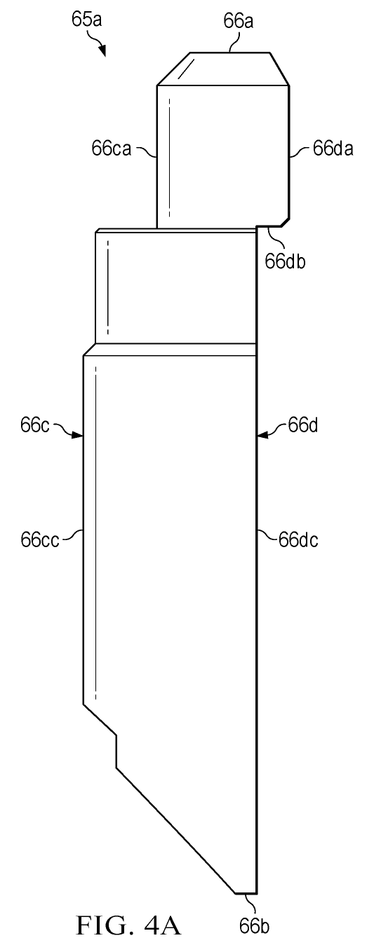

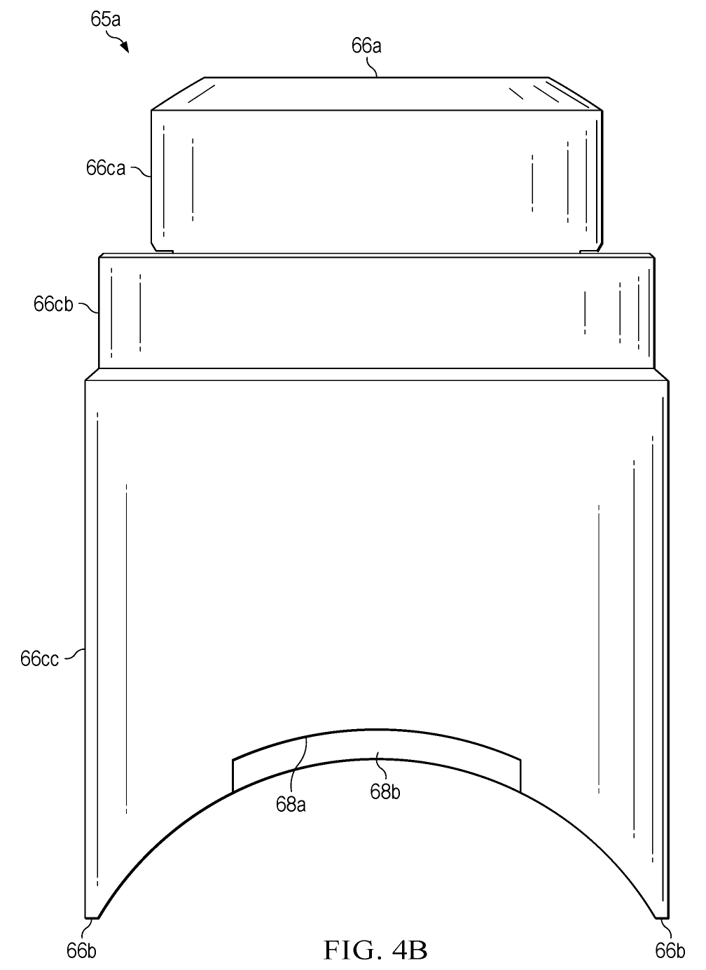

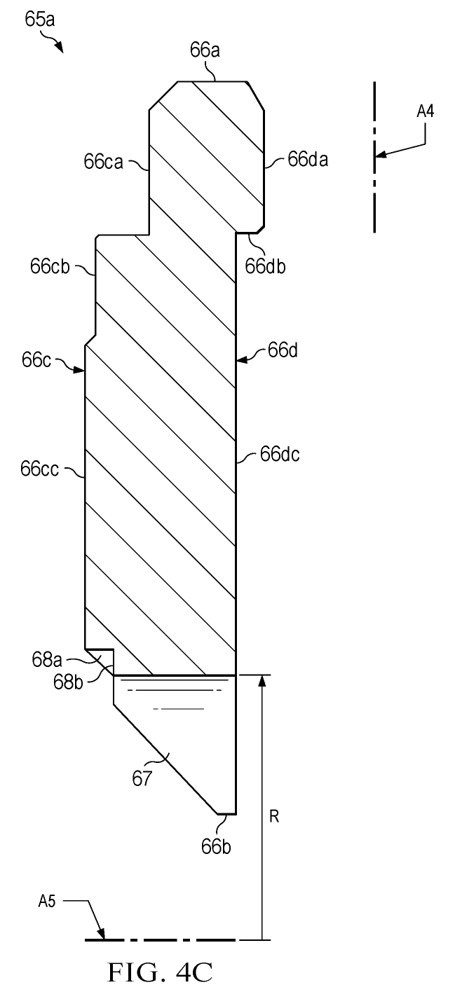

Referring also to FIGS. 4A-4C, with continuing reference to FIG. 3, the volumetric insert 65a is illustrated according to one or more embodiments of the present disclosure, with FIG. 4A illustrating a front elevational view of the volumetric insert 65a, FIG. 4B illustrating a side elevational view of the volumetric insert 65a, and FIG. 4C illustrating a cross-sectional view of the volumetric insert 65a taken along the line 4C-4C of FIG. 4B.

The volumetric insert 65a defines opposing end faces 66a, 66b, an outer portion 66c, and an inner portion 66d; each of the inner portion 66c and the outer portion 66d extends between the opposing end faces 66a, 66b. In one or more embodiments, the outer portion 66c includes a reduced-diameter (e.g., generally semi-cylindrical) surface 66ca proximate the end face 66a, an enlarged-diameter (e.g., generally semi-cylindrical) surface 66cc proximate the end face 66b, and an intermediate-diameter (e.g., generally semi-cylindrical) surface 66cb extending between the reduced-diameter surface 66ca and the enlarged-diameter surface 66cc. In one or more embodiments, each of the reduced-diameter surface 66ca, the enlarged-diameter surface 66cc, and the intermediate-diameter surface 66cb extends along a center axis A4. In one or more embodiments the center axis A4 is substantially coaxial with the center axis A1 of the valve body 15. In one or more embodiments, the inner portion 66d includes an inset (e.g., planar) surface 66da proximate the end face 66a, an outset (e.g., planar) surface 66dc extending between the inset surface 66da and the end face 66b, and an internal shoulder 66db defined between the inset surface 66da and the outset surface 66dc and facing toward the end face 66b. In one or more embodiments, the grease retainer plate 60a abuts, or nearly abuts, the internal shoulder 66db of the volumetric insert 65a in such a manner that the internal shoulder 66db supports the grease retainer plate 60a against the valve seat 55a.

A recess 67 is formed along a center axis A5 and through each of the end face 66b, the enlarged-diameter surface 66cc, and the outset surface 66dc. In one or more embodiments, the recess 67 is generally semi-cylindrical. The center axis A5 is perpendicular to the center axis A4 along which each of the reduced-diameter surface 66ca, the enlarged-diameter surface 66cc, and the intermediate-diameter surface 66cb are formed. The recess 67 has a radius R (from the center axis A5). In one or more embodiments, the radius R of the recess 67 is approximately the same as a corresponding radius of the enlarged-diameter portion 58a of the seat element 55a. As a result, the recess 67 of the volumetric insert 65a receives the valve seat 55a in such a manner that the volumetric insert 65a partially circumscribes the enlarged-diameter portion 58a of the valve seat 55a. A semi-annular recess 68a is formed in the volumetric insert 65a adjacent the recess 67. The semi-annular recess 68a adjoins the enlarged-diameter surface 66cc and defines an annular shoulder 68b in the volumetric insert 65a. In one or more embodiments, a biasing member such as, for example, a pair of spring washers 69aa, 69ab (visible in FIG. 3) are accommodated within the annular recess 68a in such a manner as to support the seat element 55a against the internal annular shoulder 47 of the valve body 15.

Similarly, the valve seat assembly 20b includes a seat element 55b, a corresponding grease retainer plate 60b, and a corresponding volumetric insert 65b. In one or more embodiments, the grease retainer plate 60b and the volumetric insert 65b are together referred to as an embodiment of a “grease retention apparatus”. In one or more embodiments, the seat element 55b is substantially identical (or at least similar) to the seat element 55a, such that any substantially identical features/components thereof are referred to herein by the same reference numerals. Thus, the end face 56a of the seat element 55b abuts, or nearly abuts, the internal annular shoulder 53 in the valve body 15. Additionally, in one or more embodiments, the grease retainer plate 60b is substantially identical (or at least similar) to the grease retainer plate 60a, such that any substantially identical features/components thereof are referred to herein by the same reference numerals. Thus, the grease retainer plate 60b partially circumscribes an exterior of the seat element 55b and is supported, for example, in a substantially parallel relation to the grease retainer plate 60a. Specifically, in one or more embodiments, the grease retainer plate 60a partially circumscribes the exterior of the seat element 55b so as to abut, or nearly abut, the external annular shoulder 58c thereof. In one or more embodiments, when so positioned, at least a portion of the grease retainer plate 60b is substantially co-planar with the end face 56b of the seat element 55b. Finally, in one or more embodiments, the volumetric insert 65b is substantially identical (or at least similar) to the volumetric insert 65a, such that any substantially identical features/components thereof are referred to herein by the same reference numerals. Thus, the grease retainer plate 60b abuts, or nearly abuts, the internal shoulder 66db of the volumetric insert 65b in such a manner that the internal shoulder 66db supports the grease retainer plate 60b against the valve seat 55b (and in a parallel relation to the grease retainer plate 60a). Moreover, the recess 67 of the volumetric insert 65b receives the valve seat 55b in such a manner that the volumetric insert 65b partially circumscribes the enlarged-diameter portion 58a of the valve seat 55b. Also, a biasing member such as, for example, a pair of spring washers 69ba, 69bb (visible in FIG. 3) are accommodated within the annular recess 68a of the volumetric insert 65b in such a manner as to support the seat element 55b against the internal annular shoulder 51 of the valve body 15.

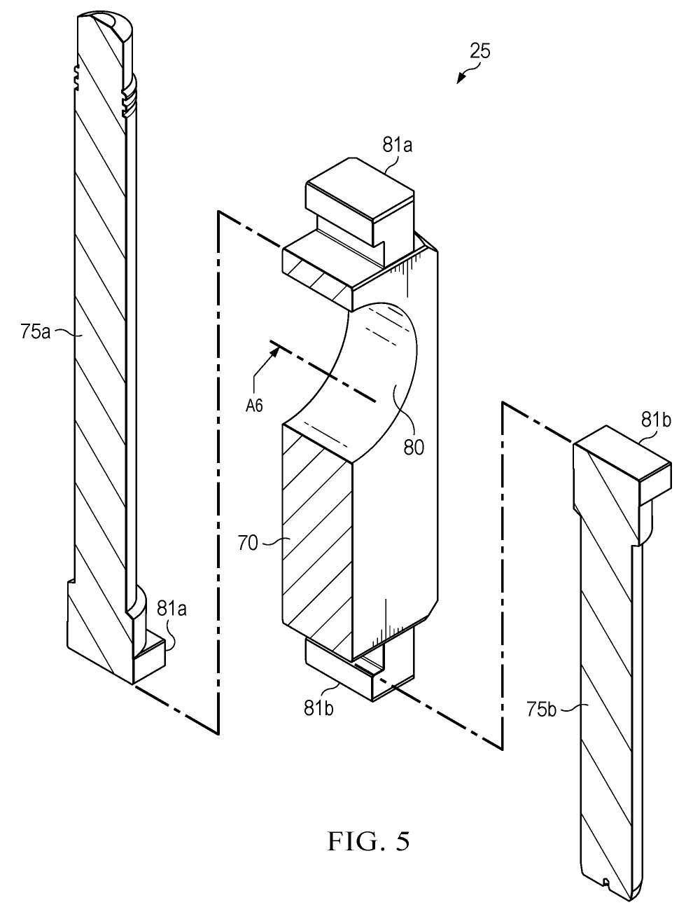

Referring to FIG. 5, with continuing reference to FIGS. 1A-4C, in one or more embodiments, the gate assembly 25 includes a gate body 70, an operating stem 75a connected to the gate body 70, and a balance stem 75b connected to the gate body 70, opposite the operating stem 75a. A fluid bore 80 extends through the gate body 70 along a center axis A6. In one or more embodiments, the fluid bore 80 is generally cylindrical. The gate body 70 is constrained on one side by the valve seat assembly 20a (including the seat element 55a, the grease retainer plate 60a, and the volumetric insert 65a), and, on the other side, by the valve seat assembly 20b (including the seat element 55b, the grease retainer plate 60b, and the volumetric insert 65b). When so constrained, the gate body 70 is adapted to move linearly between the open configuration, in which the fluid bore 80 of the gate body 70 is fully aligned with the corresponding fluid bores 59 of the seat elements 55a, 55b, and the closed configuration, in which the fluid bore 80 of the gate body 70 is fully misaligned with the corresponding fluid bores 59 of the seat elements 55a, 55b. The operating stem 75a and the balance stem 75b are connected to opposing end portions of the gate body 70, via a pair of gate connectors 81a and 81b, respectively (e.g., T-slot connectors). In one or more embodiments, the operating stem 75a and the balance stem 75b connected to the opposing end portions of the gate body 70 are substantially co-axial. Moreover, in one or more embodiments, the operating stem 75a and the balance stem 75b are substantially co-axial with the center axis A1 of the valve body 15.

The portion of the internal region 40 surrounding the valve seat assemblies 20a, 20b and the gate assembly 25 is typically filled with grease, and may be referred to herein as a “grease volume” of the gate valve 10. The grease retainer plates 60a, 60b and the volumetric inserts 65a, 65b help to keep the turbulence of the fluid flowing through the gate valve 10 from washing out the body grease when the gate body 70 is stroked between the open configuration and the closed configuration.

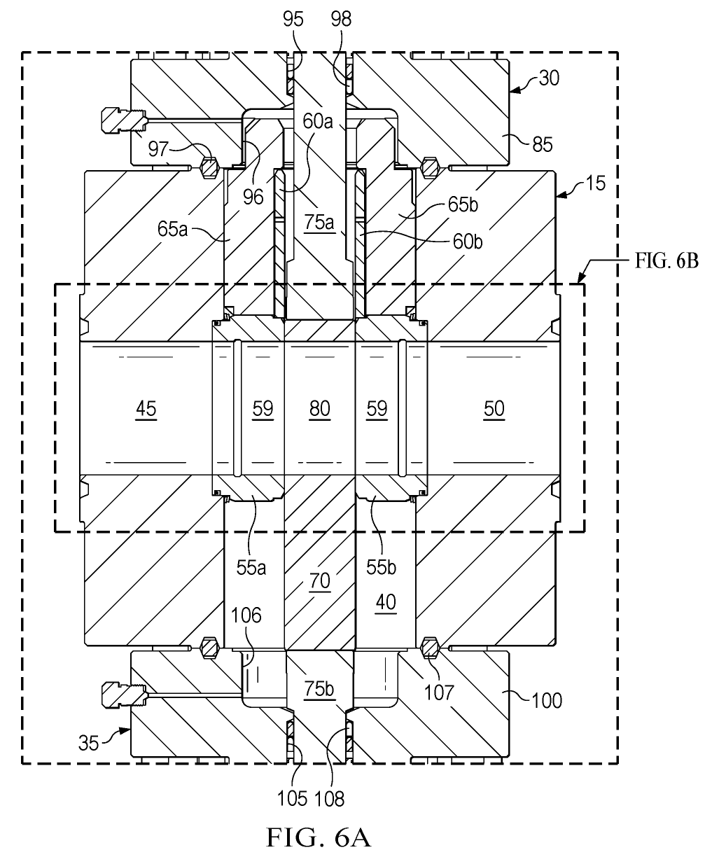

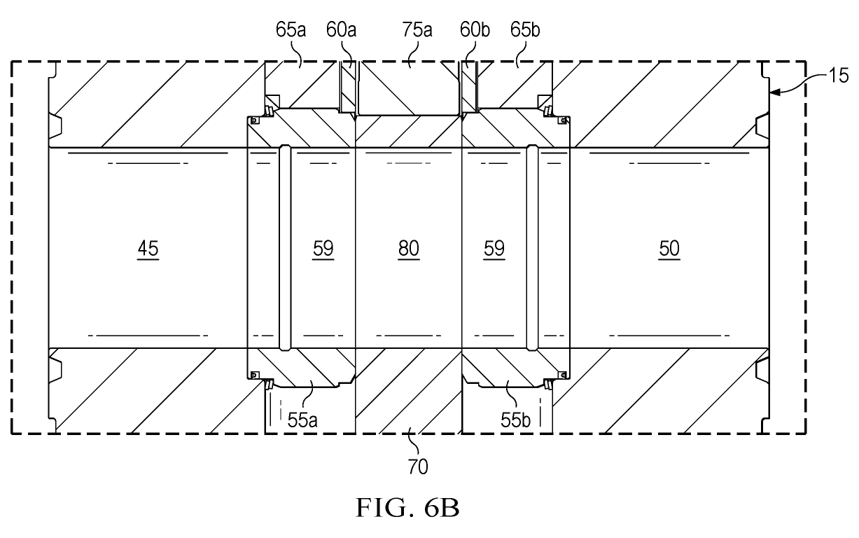

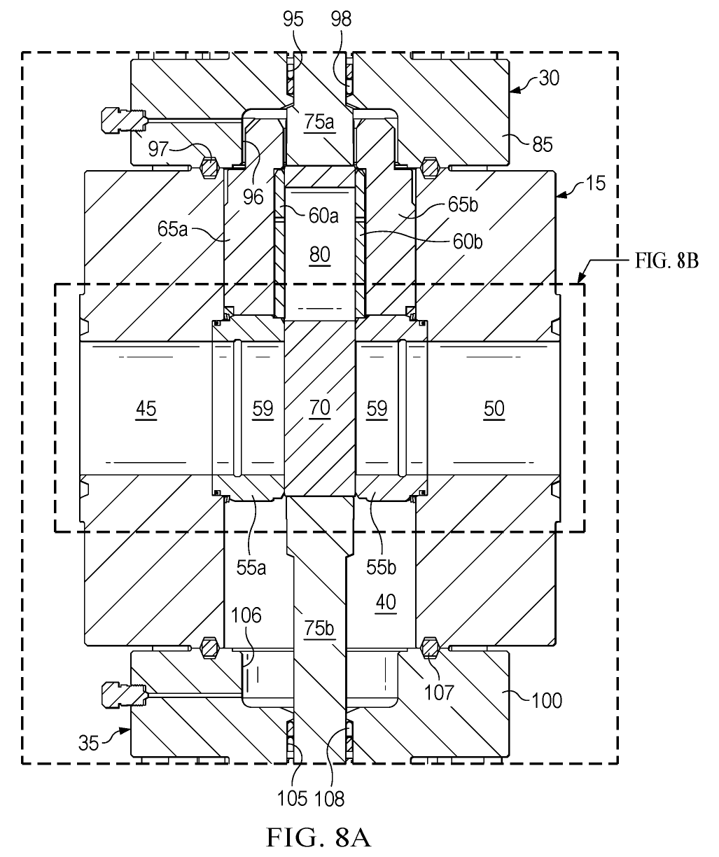

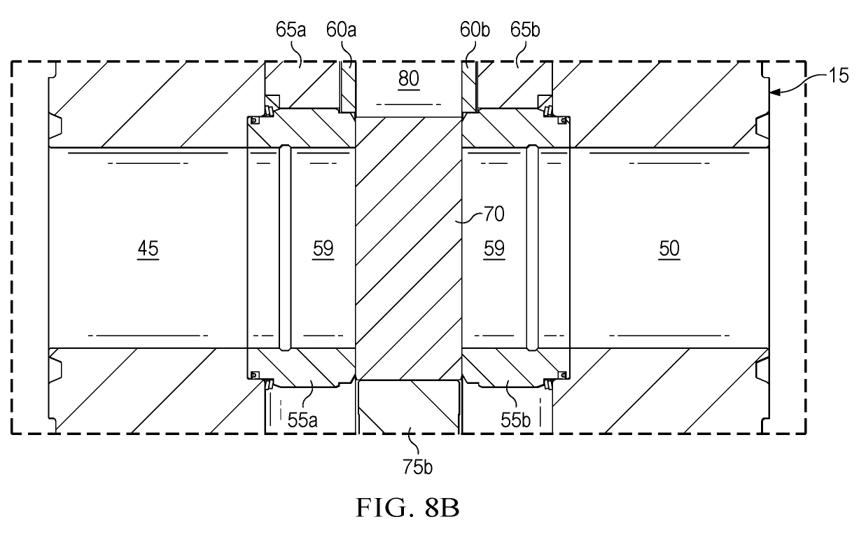

Referring to FIGS. 6A and 6B, with continuing reference to FIGS. 1A-5, in one or more embodiments, the operating end assembly 30 includes a bonnet 85 and a linear actuator 90 (visible in FIGS. 1A and 1B) connected to the bonnet 85. The bonnet 85 is connected to the valve body 15 via, for example, a plurality of fasteners. An internal passage 95 extends through the bonnet 85. In one or more embodiments, the internal passage 95 is generally cylindrical. In one or more embodiments, the internal passage 95 of the bonnet 85 is substantially co-axial with the center axis A1 of the valve body 15. In one or more embodiments, the internal passage 95 accommodates the gate connector 81a of the operating stem 75a when the gate assembly 25 is in the closed configuration (as shown in FIGS. 8A and 8B).

An annular recess 96 is formed in the internal passage 95, adjacent the valve body 15. In one or more embodiments, the annular recess 96 is, includes, or is part of the internal passage 95. In addition to the portion of the internal region 40 surrounding the seat elements 55a, 55b and the gate assembly 25, the “grease volume” of the gate valve 10 may also include the annular recess 96 of the bonnet 85 of the operating end assembly 30. An annular seal 97 sealingly engages both the valve body 15 and the bonnet 85. The operating end assembly 30 also includes a sealing (e.g., packing) element 98 that provides both a static and a dynamic seal between the bonnet 85 and the operating stem 75a of the gate assembly 25.

Similarly, the balancing end assembly 35 includes a bonnet 100 (also visible in FIGS. 1A and 1B). The bonnet 100 is connected to the valve body 15, opposite the bonnet 85, via, for example, a plurality of fasteners. An internal passage 105 extends through the bonnet 100. In one or more embodiments, the internal passage 105 is generally cylindrical. In one or more embodiments, the internal passage 105 of the bonnet 100 is substantially co-axial with the center axis A1 of the valve body 15. In one or more embodiments, the internal passage 105 accommodates the gate connector 81b of the balance stem 75b when the gate assembly 25 is in the open configuration (as shown in FIGS. 6A and 6B).

An annular recess 106 is formed in the internal passage 105, adjacent the valve body 15. In one or more embodiments, the annular recess 106 is, includes, or is part of the internal passage 105. In addition to the portion of the internal region 40 surrounding the seat elements 55a, 55b and the gate assembly 25, the “grease volume” of the gate valve 10 may also include the annular recess 106 of the bonnet 100 of the balancing end assembly 35. An annular seal 107 sealingly engages both the valve body 15 and the bonnet 100. The balancing end assembly 35 also includes a sealing (e.g., packing) element 108 that provides both a static and a dynamic seal between the bonnet 100 and the balance stem 75b of the gate assembly 25.

Referring still to FIGS. 6A and 6B, with continuing reference to FIGS. 1A-5, the gate valve 10 is illustrated in an open configuration, according to one or more embodiments of the present disclosure.

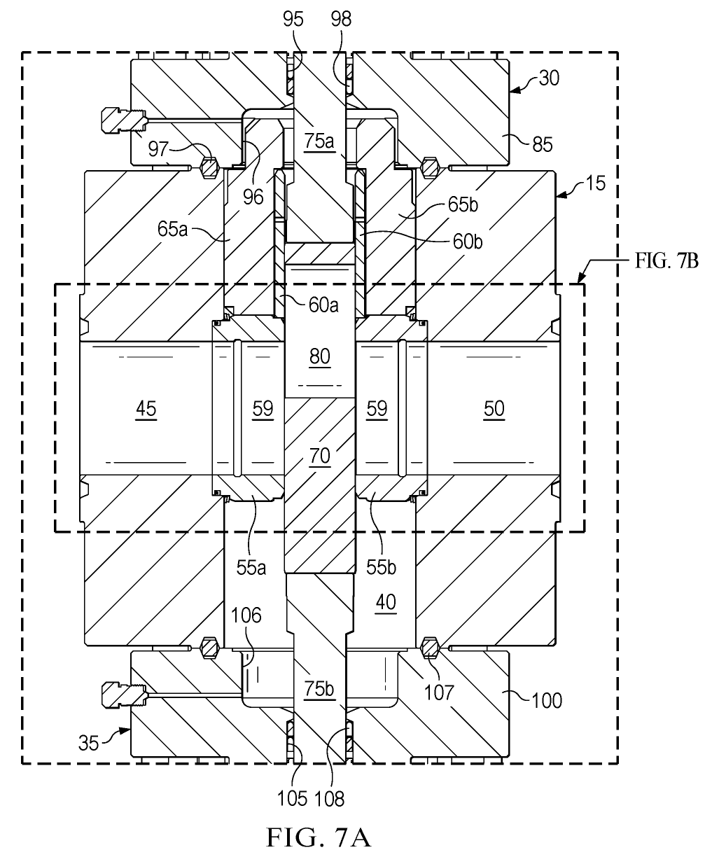

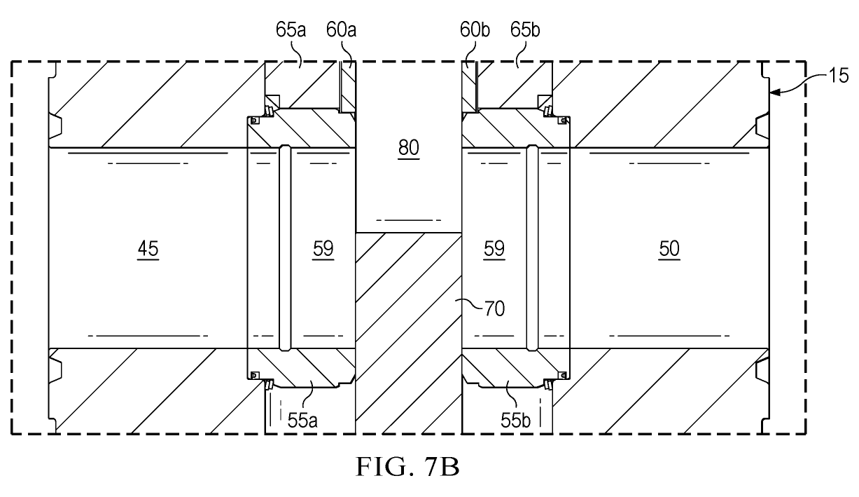

Referring to FIGS. 7A and 7B, with continuing reference to FIGS. 1A-6B, the gate valve 10 is illustrated in a state of transition between the open configuration and a closed configuration, according to one or more embodiments of the present disclosure.

Referring to FIGS. 8A and 8B, with continuing reference to FIGS. 1A-7B, the gate valve is illustrated in the closed configuration, according to one or more embodiments of the present disclosure.

Referring back to FIGS. 6A-8B, with continuing reference to FIGS. 1A-5, when the gate valve 10 is fully assembled for use, the grease retainer plates 60a, 60b and the volumetric inserts 65a, 65b help keep the gate body 70 on track, remove empty space that would otherwise be taken up by grease, and isolate the turbulence of the fluid flowing through the gate valve 10 when the gate body 70 is stroked between the open configuration and the closed configuration. Accordingly, in one or more embodiments, the gate valve 10 requires less grease after every stage and/or before the next stage during hydraulic fracturing operations, as compared to grease requirements of a gate valve that does not include at least the volumetric inserts 65a, 65b; in one or more embodiments, the gate valve 10 eliminates the need for more grease after a stage and/or before the next stage during hydraulic fracturing operations; in one or more embodiments, the operation of the gate valve 10 eliminates the need for more grease after a stage and/or before the next stage during hydraulic fracturing operations; in one or more embodiments, the volumetric inserts 65a, 65b eliminate the need for more grease after a stage and/or before the next stage during hydraulic fracturing operations; in one or more embodiments, the gate valve 10 is a gate valve with reduced grease usage, as compared to a gate valve that is different from the gate valve 10; in one or more embodiments, the gate valve 10 extends greasing intervals, with each greasing interval being the time period between when grease is added to the gate valve 10 (and/or the gate valve 10 is lubricated and/or greased) and the next time grease is added to the gate valve 10 (and/or the gate valve 10 is lubricated and/or greased); in one or more embodiments, the gate valve 10 reduces grease use.

In one or more embodiments, a method of assembling the gate valve 10 includes placing the gate valve 10 in the assembled condition described above and illustrated in FIGS. 6A-8B. In one or more embodiments, a method of disassembling the gate valve 10 includes placing the gate valve 10 in an unassembled condition.

In one or more embodiments, a method of retrofitting the gate valve 10 includes at least partially disassembling the gate valve 10, removing any existing gate guides, and reassembling the gate valve 10 with the seat assemblies 20a, 20b, including the grease retainer plates 60a, 60b and the volumetric inserts 65a, 65b. In one or more embodiments, the ability to retrofit the gate valve 10 increases the operational life of the gate valve 10 as a whole.

In one or more embodiments, at least partially disassembling the gate valve 10 to, for example, retrofit the gate valve 10 in accordance with the foregoing, includes: disconnecting the operating end assembly 30 from the valve body 15, disconnecting the balancing end assembly 35 from the valve body 15, removing the gate assembly 25 from the valve body 15 to provide access to the internal region 40, and removing any existing valve seat assemblies from the valve body 15.

One or more embodiments of the present application are provided in whole or in part as described in the ’344 Application, including the Appendix of the ’344 Application, the entire disclosure of which has been incorporated herein by reference. It is understood that one or more of the embodiments described above and shown FIGS. 1A-8B may be combined in whole or in part with one or more of the embodiments described and illustrated in the ’344 Application, including the Appendix of the ’344 Application, and/or one or more other embodiments described above and shown in FIGS. 1A-8B.

A gate valve has been introduced according to one or more aspects of the present disclosure. In one or more aspects, the gate valve includes: a valve body; first and second annular seat elements extending within the valve body; a gate body extending within the valve body and seated between the first and second annular seat elements so as to be movable between: an open configuration in which a fluid bore of the gate body is at least partially aligned with respective fluid bores of the first and second annular seat elements to allow fluid flow through the valve body via the fluid bore of the gate body and the respective fluid bores of the first and second annular seat elements; and a closed configuration in which the fluid bore of the gate body is fully misaligned with the respective fluid bores of the first and second annular seat elements to prevent, or at least restrict, fluid flow through the valve body via the fluid bore of the gate body; a first volumetric insert extending within the valve body, wherein the first volumetric insert defines: opposing inner and outer surfaces extending between opposing ends of the first volumetric insert, the outer surface being curved; and a recess formed through both the inner and outer surfaces of the first volumetric insert at one of the opposing ends thereof, the recess receiving the first annular seat element in such a manner that the first volumetric insert: at least partially circumscribes the first annular seat element; and occupies space in the valve body that would otherwise be taken up by grease; and a first grease retainer plate extending within the valve body and adjacent the inner surface of the first volumetric insert, wherein the first grease retainer plate at least partially circumscribes the first annular seat element to prevent, or at least reduce, grease washout from the valve body when the gate body is moved between the open configuration and the closed configuration. In one or more aspects, the first volumetric insert is made of nonmetallic material and the first grease retainer plate is made of metallic material. In one or more aspects, the gate valve further includes a bonnet connected to the valve body, wherein the first volumetric insert also extends within the bonnet. In one or more aspects, the first volumetric insert further defines an internal shoulder adjacent the inner surface of the first volumetric insert, which internal shoulder supports the first grease retainer plate against the first annular seat element. In one or more aspects, the gate valve further includes first and second biasing members positioned between the valve body and the respective first and second annular seat elements, wherein the first and second biasing members push the respective first and second annular seat elements towards the gate body. In one or more aspects, the gate valve further includes first and second annular seals positioned between the valve body and the respective first and second annular seat elements, wherein the first and second annular seals sealingly engage both the valve body and respective radially exterior surfaces of the first and second annular seat elements. In one or more aspects, the gate valve further includes: a second volumetric insert extending within the valve body, wherein the second volumetric insert defines: opposing inner and outer surfaces extending between opposing ends of the second volumetric insert, the outer surface being curved; and a recess formed through both the inner and outer surfaces of the second volumetric insert at one of the opposing ends thereof, the recess receiving the second annular seat element in such a manner that the second volumetric insert: at least partially circumscribes the second annular seat element; and occupies space in the valve body that would otherwise be taken up by grease; and a second grease retainer plate extending within the valve body and adjacent the inner surface of the second volumetric insert, wherein the second grease retainer plate at least partially circumscribes the second annular seat element to prevent, or at least reduce, grease washout from the valve body when the gate body is moved between the open configuration and the closed configuration. In one or more aspects, the first and second volumetric inserts are made of nonmetallic material and the first and second grease retainer plates are made of metallic material. In one or more aspects, the gate valve further includes a bonnet connected to the valve body, wherein the first and second volumetric inserts also extend within the bonnet. In one or more aspects, the first volumetric insert further defines an internal shoulder adjacent the inner surface of the first volumetric insert, which internal shoulder supports the first grease retainer plate against the first annular seat element; and the second volumetric insert further defines an internal shoulder adjacent the inner surface of the second volumetric insert, which internal shoulder supports the second grease retainer plate against the second annular seat element.

A valve body for a gate valve has also been introduced according to one or more aspects of the present disclosure.

A valve seat assembly for a gate valve has also been introduced according to one or more aspects of the present disclosure.

A grease retention apparatus for a gate valve has also been introduced according to one or more aspects of the present disclosure. In one or more aspects, the grease retention apparatus includes: a volumetric insert adapted to extend within a valve body of the gate valve, the volumetric insert defining: opposing inner and outer surfaces extending between opposing ends of the volumetric insert, the outer surface being curved; and a recess formed through both the inner and outer surfaces of the volumetric insert at one of the opposing ends thereof; and a grease retainer plate also adapted to extend within the valve body of the gate valve, adjacent the inner surface of the volumetric insert; wherein, when the volumetric insert and the grease retainer plate extend within the valve body of the gate valve: a gate body of the gate valve is adapted to be seated against an annular seat element of the gate valve so as to be movable between: an open configuration in which a fluid bore of the gate body is at least partially aligned with a fluid bore of the annular seat element to allow fluid flow through the valve body of the gate valve via the fluid bore of the gate body and the fluid bore of the annular seat element; and a closed configuration in which the fluid bore of the gate body is fully misaligned with the fluid bore of the annular seat element to prevent, or at least restrict fluid flow, through the valve body of the gate valve via the fluid bore of the gate body; and wherein, when the volumetric insert and the grease retainer plate extend within the valve body of the gate valve and the gate body of the gate valve is seated against the annular seat element of the gate valve so as to be movable between the open configuration and the closed configuration: the recess of the volumetric insert receives the annular seat element of the gate valve in such a manner that the volumetric insert at least partially circumscribes the annular seat element of the gate valve and occupies space in the valve body of the gate valve that would otherwise be taken up by grease; and the grease retainer plate at least partially circumscribes the annular seat element of the gate valve to prevent, or at least reduce, grease washout from the valve body of the gate valve when the gate body of the gate valve is moved between the open configuration and the closed configuration. In one or more aspects, the volumetric insert is made of nonmetallic material and/or the grease retainer plate is made of metallic material. In one or more aspects, the volumetric insert is made of the nonmetallic material and the grease retainer plate is made of the metallic material. In one or more aspects, when the volumetric insert and the grease retainer plate extend within the valve body of the gate valve and the gate body of the gate valve is seated against the annular seat element of the gate valve so as to be movable between the open configuration and the closed configuration, the volumetric insert of the grease retention apparatus also extends within a bonnet connected to the valve body of the gate valve. In one or more aspects, the volumetric insert further defines an internal shoulder adjacent the inner surface of the volumetric insert, which internal shoulder supports the grease retainer plate against the annular seat element.

A seat element for a gate valve has also been introduced according to one or more aspects of the present disclosure.

A grease retainer plate for a gate valve has also been introduced according to one or more aspects of the present disclosure.

A volumetric insert for a gate valve has also been introduced according to one or more aspects of the present disclosure.

A gate assembly for a gate valve has also been introduced according to one or more aspects of the present disclosure.

A gate body for a gate valve has also been introduced according to one or more aspects of the present disclosure.

An operating stem for a gate valve has also been introduced according to one or more aspects of the present disclosure.

A balance stem for a gate valve has also been introduced according to one or more aspects of the present disclosure.

An operating end assembly for a gate valve has also been introduced according to one or more aspects of the present disclosure.

A balance end assembly for a gate valve has also been introduced according to one or more aspects of the present disclosure.

An apparatus has also been introduced according to one or more aspects of the present disclosure.

A system has also been introduced according to one or more aspects of the present disclosure.

A retrofitting kit for a gate valve has also been introduced according to one or more aspects of the present disclosure.

A method of operating a gate valve has also been introduced according to one or more aspects of the present disclosure. In one or more aspects, the method includes: moving a gate body extending within a valve body of the gate valve, which gate body is seated between first and second annular seat elements extending within the valve body of the gate valve, between: an open configuration in which a fluid bore of the gate body is at least partially aligned with respective fluid bores of the first and second annular seat elements to allow fluid flow through the valve body of the gate valve via the fluid bore of the gate body and the respective fluid bores of the first and second annular seat elements; and a closed configuration in which the fluid bore of the gate body is fully misaligned with the respective fluid bores of the first and second annular seat elements to prevent, or at least restrict, fluid flow through the valve body of the gate valve via the fluid bore of the gate body; while moving the gate body between the open configuration and the closed configuration: occupying space, using a first volumetric insert extending within the valve body of the gate valve, that would otherwise be taken up by grease in the valve body of the gate valve, the first volumetric insert defining: opposing inner and outer surfaces extending between opposing ends of the first volumetric insert, the outer surface being curved; and a recess formed through both the inner and outer surfaces of the first volumetric insert at one of the opposing ends thereof, the recess receiving the first annular seat element in such a manner that the first volumetric insert at least partially circumscribes the first annular seat element; and preventing, or at least reducing, using a first grease retainer plate extending within the valve body of the gate valve, grease washout from the valve body of the gate valve, the first grease retainer plate extending adjacent the inner surface of the first volumetric insert and at least partially circumscribing the first annular seat element. In one or more aspects, the first volumetric insert is made of nonmetallic material and the first grease retainer plate is made of metallic material. In one or more aspects, a bonnet is connected to the valve body of the gate valve; and the first volumetric insert also extends within the bonnet. In one or more aspects, the first volumetric insert further defines an internal shoulder adjacent the inner surface of the first volumetric insert, which internal shoulder supports the first grease retainer plate against the first annular seat element. In one or more aspects, the method further includes: pushing, using first and second biasing members positioned between the valve body of the gate valve and the respective first and second annular seat elements, the respective first and second annular seat elements towards the gate body. In one or more aspects, the method further includes: sealingly engaging, using first and second annular seals positioned between the valve body of the gate valve and the respective first and second annular seat elements, both the valve body of the gate valve and respective radially exterior surfaces of the first and second annular seat elements. In one or more aspects, the method further includes: while moving the gate body between the open configuration and the closed configuration: occupying space, using a second volumetric insert extending within the valve body of the gate valve, that would otherwise be taken up by grease in the valve body of the gate valve, the second volumetric insert defining: opposing inner and outer surfaces extending between opposing ends of the second volumetric insert, the outer surface being curved; and a recess formed through both the inner and outer surfaces of the second volumetric insert at one of the opposing ends thereof, the recess receiving the second annular seat element in such a manner that the second volumetric insert at least partially circumscribes the second annular seat element; and preventing, or at least reducing, using a second grease retainer plate extending within the valve body of the gate valve, grease washout from the valve body of the gate valve, the second grease retainer plate extending adjacent the inner surface of the second volumetric insert and at least partially circumscribing the second annular seat element. In one or more aspects, the first and second volumetric inserts are made of nonmetallic material and the first and second grease retainer plates are made of metallic material. In one or more aspects, a bonnet is connected to the valve body of the gate valve; and the first and second volumetric inserts also extend within the bonnet. In one or more aspects, the first volumetric insert further defines an internal shoulder adjacent the inner surface of the first volumetric insert, which internal shoulder supports the first grease retainer plate against the first annular seat element; and the second volumetric insert further defines an internal shoulder adjacent the inner surface of the second volumetric insert, which internal shoulder supports the second grease retainer plate against the second annular seat element.

Another method of operating a gate valve has also been introduced according to one or more aspects of the present disclosure. In one or more aspects, the another method includes: moving a gate body extending within a valve body of the gate valve, which gate body is seated against an annular seat element extending within the valve body of the gate valve, between: an open configuration in which a fluid bore of the gate body is at least partially aligned with a fluid bore of the annular seat element to allow fluid flow through the valve body of the gate valve via the fluid bore of the gate body and the fluid bore of the annular seat element; and a closed configuration in which the fluid bore of the gate body is fully misaligned with the fluid bore of the annular seat element to prevent, or at least restrict, fluid flow through the valve body of the gate valve via the fluid bore of the gate body; while moving the gate body between the open configuration and the closed configuration: occupying space, using a volumetric insert extending within the valve body of the gate valve, that would otherwise be taken up by grease in the valve body of the gate valve, the volumetric insert defining: opposing inner and outer surfaces extending between opposing ends of the volumetric insert, the outer surface being curved; and a recess formed through both the inner and outer surfaces of the volumetric insert at one of the opposing ends thereof, the recess receiving the first annular seat element in such a manner that the volumetric insert at least partially circumscribes the first annular seat element; and preventing, or at least reducing, using a grease retainer plate extending within the valve body, grease washout from the valve body, the grease retainer plate extending adjacent the inner surface of the volumetric insert and at least partially circumscribing the first annular seat element. In one or more aspects, the volumetric insert is made of nonmetallic material and/or the grease retainer plate is made of metallic material. In one or more aspects, the volumetric insert is made of the nonmetallic material and the grease retainer plate is made of the metallic material. In one or more aspects, a bonnet is connected to the valve body of the gate valve; and the volumetric insert also extends within the bonnet. In one or more aspects, the volumetric insert further defines an internal shoulder adjacent the inner surface of the volumetric insert, which internal shoulder supports the grease retainer plate against the annular seat element.

A method of assembling a gate valve has also been introduced according to one or more aspects of the present disclosure.

A method of controlling fluid flow has also been introduced according to one or more aspects of the present disclosure.

A method of retrofitting a gate valve has also been introduced according to one or more aspects of the present disclosure.

It is further understood that variations may be made in the foregoing without departing from the scope of the disclosure.

In one or more embodiments, the elements and teachings of the various embodiments disclosed herein may be combined in whole or in part in some or all of said embodiment(s). In addition, one or more of the elements and teachings of the various embodiments disclosed herein may be omitted, at least in part, or combined, at least in part, with one or more of the other elements and teachings of said embodiment(s).

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In one or more embodiments, while different steps, processes, and procedures are described as appearing as distinct acts, one or more of the steps, one or more of the processes, or one or more of the procedures may also be performed in different orders, simultaneously or sequentially. In one or more embodiments, the steps, processes, or procedures may be merged into one or more steps, processes, or procedures. In one or more embodiments, one or more of the operational steps in each embodiment may be omitted. Moreover, in some instances, some features of the present disclosure may be employed without a corresponding use of the other features. Moreover, one or more of the embodiments disclosed above and in the ’344 Application, including the Appendix of the ’344 Application, or variations thereof, may be combined in whole or in part with any one or more of the other embodiments described above and in the ’344 Application, including the Appendix of the ’344 Application, or variations thereof.

Although various embodiments have been disclosed in detail above and in the ’344 Application, including the Appendix of the ’344 Application, the embodiments disclosed are exemplary only and are not limiting, and those skilled in the art will readily appreciate that many other modifications, changes, and substitutions are possible in the embodiments without materially departing from the novel teachings and advantages of the present disclosure. Accordingly, all such modifications, changes, and substitutions are intended to be included within the scope of this disclosure as defined in the following claims. In the claims, means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A gate valve, comprising:
a valve body;
first and second annular seat elements extending within the valve body;
a gate body extending within the valve body and seated between the first and second annular seat elements so as to be movable between:
an open configuration in which a fluid bore of the gate body is at least partially aligned with respective fluid bores of the first and second annular seat elements to allow fluid flow through the valve body via the fluid bore of the gate body and the respective fluid bores of the first and second annular seat elements; and
a closed configuration in which the fluid bore of the gate body is fully misaligned with the respective fluid bores of the first and second annular seat elements to prevent, or at least restrict, fluid flow through the valve body via the fluid bore of the gate body;
a first volumetric insert extending within the valve body,
wherein the first volumetric insert defines:
opposing inner and outer surfaces extending between opposing ends of the first volumetric insert, the outer surface being curved; and
a recess formed through both the inner and outer surfaces of the first volumetric insert at one of the opposing ends thereof, the recess receiving the first annular seat element in such a manner that the first volumetric insert:
at least partially circumscribes the first annular seat element; and
occupies space in the valve body that would otherwise be taken up by grease;
and
a first grease retainer plate extending within the valve body and adjacent the inner surface of the first volumetric insert,
wherein the first grease retainer plate at least partially circumscribes the first annular seat element to prevent, or at least reduce, grease washout from the valve body when the gate body is moved between the open configuration and the closed configuration.

2. The gate valve of claim 1, wherein the first volumetric insert is made of nonmetallic material and the first grease retainer plate is made of metallic material.

3. The gate valve of claim 1, further comprising a bonnet connected to the valve body, wherein the first volumetric insert also extends within the bonnet.

4. The gate valve of claim 1, wherein the first volumetric insert further defines an internal shoulder adjacent the inner surface of the first volumetric insert, which internal shoulder supports the first grease retainer plate against the first annular seat element.

5. The gate valve of claim 1, further comprising first and second biasing members positioned between the valve body and the respective first and second annular seat elements, wherein the first and second biasing members push the respective first and second annular seat elements towards the gate body.

6. The gate valve of claim 5, further comprising first and second annular seals positioned between the valve body and the respective first and second annular seat elements, wherein the first and second annular seals sealingly engage both the valve body and respective radially exterior surfaces of the first and second annular seat elements.

7. The gate valve of claim 1, further comprising:
a second volumetric insert extending within the valve body,
wherein the second volumetric insert defines:
opposing inner and outer surfaces extending between opposing ends of the second volumetric insert, the outer surface being curved; and
a recess formed through both the inner and outer surfaces of the second volumetric insert at one of the opposing ends thereof, the recess receiving the second annular seat element in such a manner that the second volumetric insert:
at least partially circumscribes the second annular seat element; and
occupies space in the valve body that would otherwise be taken up by grease;
and
a second grease retainer plate extending within the valve body and adjacent the inner surface of the second volumetric insert,
wherein the second grease retainer plate at least partially circumscribes the second annular seat element to prevent, or at least reduce, grease washout from the valve body when the gate body is moved between the open configuration and the closed configuration.

8. The gate valve of claim 7, wherein the first and second volumetric inserts are made of nonmetallic material and the first and second grease retainer plates are made of metallic material.

9. The gate valve of claim 7, further comprising a bonnet connected to the valve body, wherein the first and second volumetric inserts also extend within the bonnet.

10. The gate valve of claim 7, wherein the first volumetric insert further defines an internal shoulder adjacent the inner surface of the first volumetric insert, which internal shoulder supports the first grease retainer plate against the first annular seat element; and
wherein the second volumetric insert further defines an internal shoulder adjacent the inner surface of the second volumetric insert, which internal shoulder supports the second grease retainer plate against the second annular seat element.

11. A grease retention apparatus for a gate valve, the grease retention apparatus comprising:
a volumetric insert adapted to extend within a valve body of the gate valve, the volumetric insert defining:
opposing inner and outer surfaces extending between opposing ends of the volumetric insert, the outer surface being curved; and
a recess formed through both the inner and outer surfaces of the volumetric insert at one of the opposing ends thereof;
and
a grease retainer plate also adapted to extend within the valve body of the gate valve, adjacent the inner surface of the volumetric insert;
wherein, when the volumetric insert and the grease retainer plate extend within the valve body of the gate valve:
a gate body of the gate valve is adapted to be seated against an annular seat element of the gate valve so as to be movable between:
an open configuration in which a fluid bore of the gate body is at least partially aligned with a fluid bore of the annular seat element to allow fluid flow through the valve body of the gate valve via the fluid bore of the gate body and the fluid bore of the annular seat element; and
a closed configuration in which the fluid bore of the gate body is fully misaligned with the fluid bore of the annular seat element to prevent, or at least restrict fluid flow, through the valve body of the gate valve via the fluid bore of the gate body;
and
wherein, when the volumetric insert and the grease retainer plate extend within the valve body of the gate valve and the gate body of the gate valve is seated against the annular seat element of the gate valve so as to be movable between the open configuration and the closed configuration:
the recess of the volumetric insert receives the annular seat element of the gate valve in such a manner that the volumetric insert at least partially circumscribes the annular seat element of the gate valve and occupies space in the valve body of the gate valve that would otherwise be taken up by grease; and
the grease retainer plate at least partially circumscribes the annular seat element of the gate valve to prevent, or at least reduce, grease washout from the valve body of the gate valve when the gate body of the gate valve is moved between the open configuration and the closed configuration.

12. The grease retention apparatus of claim 11, wherein the volumetric insert is made of nonmetallic material and/or the grease retainer plate is made of metallic material.

13. The grease retention apparatus of claim 12, wherein the volumetric insert is made of the nonmetallic material and the grease retainer plate is made of the metallic material.

14. The grease retention apparatus of claim 11, wherein, when the volumetric insert and the grease retainer plate extend within the valve body of the gate valve and the gate body of the gate valve is seated against the annular seat element of the gate valve so as to be movable between the open configuration and the closed configuration, the volumetric insert of the grease retention apparatus also extends within a bonnet connected to the valve body of the gate valve.

15. The grease retention apparatus of claim 11, wherein the volumetric insert further defines an internal shoulder adjacent the inner surface of the volumetric insert, which internal shoulder supports the grease retainer plate against the annular seat element.

16. A method of operating a gate valve, the method comprising:
moving a gate body extending within a valve body of the gate valve, which gate body is seated between first and second annular seat elements extending within the valve body of the gate valve, between:
an open configuration in which a fluid bore of the gate body is at least partially aligned with respective fluid bores of the first and second annular seat elements to allow fluid flow through the valve body of the gate valve via the fluid bore of the gate body and the respective fluid bores of the first and second annular seat elements; and
a closed configuration in which the fluid bore of the gate body is fully misaligned with the respective fluid bores of the first and second annular seat elements to prevent, or at least restrict, fluid flow through the valve body of the gate valve via the fluid bore of the gate body;
while moving the gate body between the open configuration and the closed configuration:
occupying space, using a first volumetric insert extending within the valve body of the gate valve, that would otherwise be taken up by grease in the valve body of the gate valve, the first volumetric insert defining:
opposing inner and outer surfaces extending between opposing ends of the first volumetric insert, the outer surface being curved; and
a recess formed through both the inner and outer surfaces of the first volumetric insert at one of the opposing ends thereof, the recess receiving the first annular seat element in such a manner that the first volumetric insert at least partially circumscribes the first annular seat element;
and
preventing, or at least reducing, using a first grease retainer plate extending within the valve body of the gate valve, grease washout from the valve body of the gate valve, the first grease retainer plate extending adjacent the inner surface of the first volumetric insert and at least partially circumscribing the first annular seat element.

17. The method of claim 16, wherein the first volumetric insert is made of nonmetallic material and the first grease retainer plate is made of metallic material.

18. The method of claim 16, wherein a bonnet is connected to the valve body of the gate valve; and
wherein the first volumetric insert also extends within the bonnet.

19. The method of claim 16, wherein the first volumetric insert further defines an internal shoulder adjacent the inner surface of the first volumetric insert, which internal shoulder supports the first grease retainer plate against the first annular seat element.

20. The method of claim 16, further comprising:
pushing, using first and second biasing members positioned between the valve body of the gate valve and the respective first and second annular seat elements, the respective first and second annular seat elements towards the gate body.

21. The method of claim 20, further comprising:
sealingly engaging, using first and second annular seals positioned between the valve body of the gate valve and the respective first and second annular seat elements, both the valve body of the gate valve and respective radially exterior surfaces of the first and second annular seat elements.

22. The method of claim 16, further comprising:
while moving the gate body between the open configuration and the closed configuration:
occupying space, using a second volumetric insert extending within the valve body of the gate valve, that would otherwise be taken up by grease in the valve body of the gate valve, the second volumetric insert defining:
opposing inner and outer surfaces extending between opposing ends of the second volumetric insert, the outer surface being curved; and
a recess formed through both the inner and outer surfaces of the second volumetric insert at one of the opposing ends thereof, the recess receiving the second annular seat element in such a manner that the second volumetric insert at least partially circumscribes the second annular seat element;
and
preventing, or at least reducing, using a second grease retainer plate extending within the valve body of the gate valve, grease washout from the valve body of the gate valve, the second grease retainer plate extending adjacent the inner surface of the second volumetric insert and at least partially circumscribing the second annular seat element.

23. The method of claim 22, wherein the first and second volumetric inserts are made of nonmetallic material and the first and second grease retainer plates are made of metallic material.

24. The method of claim 22, wherein a bonnet is connected to the valve body of the gate valve; and
wherein the first and second volumetric inserts also extend within the bonnet.

25. The method of claim 22, wherein the first volumetric insert further defines an internal shoulder adjacent the inner surface of the first volumetric insert, which internal shoulder supports the first grease retainer plate against the first annular seat element; and
wherein the second volumetric insert further defines an internal shoulder adjacent the inner surface of the second volumetric insert, which internal shoulder supports the second grease retainer plate against the second annular seat element.

26. A method of operating a gate valve, the method comprising:
moving a gate body extending within a valve body of the gate valve, which gate body is seated against an annular seat element extending within the valve body of the gate valve, between:
an open configuration in which a fluid bore of the gate body is at least partially aligned with a fluid bore of the annular seat element to allow fluid flow through the valve body of the gate valve via the fluid bore of the gate body and the fluid bore of the annular seat element; and
a closed configuration in which the fluid bore of the gate body is fully misaligned with the fluid bore of the annular seat element to prevent, or at least restrict, fluid flow through the valve body of the gate valve via the fluid bore of the gate body;
while moving the gate body between the open configuration and the closed configuration:
occupying space, using a volumetric insert extending within the valve body of the gate valve, that would otherwise be taken up by grease in the valve body of the gate valve, the volumetric insert defining:
opposing inner and outer surfaces extending between opposing ends of the volumetric insert, the outer surface being curved; and
a recess formed through both the inner and outer surfaces of the volumetric insert at one of the opposing ends thereof, the recess receiving the first annular seat element in such a manner that the volumetric insert at least partially circumscribes the first annular seat element;
and
preventing, or at least reducing, using a grease retainer plate extending within the valve body, grease washout from the valve body, the grease retainer plate extending adjacent the inner surface of the volumetric insert and at least partially circumscribing the first annular seat element.

27. The method of claim 26, wherein the volumetric insert is made of nonmetallic material and/or the grease retainer plate is made of metallic material.

28. The method of claim 27, wherein the volumetric insert is made of the nonmetallic material and the grease retainer plate is made of the metallic material.

29. The method of claim 26, wherein a bonnet is connected to the valve body of the gate valve; and
wherein the volumetric insert also extends within the bonnet.

30. The method of claim 26, wherein the volumetric insert further defines an internal shoulder adjacent the inner surface of the volumetric insert, which internal shoulder supports the grease retainer plate against the annular seat element.
